(19) United States
(12) Patent Application Publication
(10) Pub. No.: US 2006/0116818 A1
(43) Pub. Date: Jun. 1, 2006

(54) Method and system for multiple route navigation

(75) Inventors: Yi-Chung Chao, Fremont, CA (US); Robert Rennard, Gilroy, CA (US); Salman Dhanani, Redmond, WA (US)

Correspondence Address: IRENE HU, 2033 RALSTON AVE., PMB 146, BELMONT, CA, 94002, US

(73) Assignee: Televigation, Inc., Sunnyvale, CA (US)

(21) Appl. No.: 11/004,198

(22) Filed: Dec. 1, 2004

(51) Int. Cl. G01C 21/30

(52) U.S. Cl. 701/211; 701/208; 455/456.1; 455/457; 340/990

(57) ABSTRACT

Method and system for providing multiple route navigation guidance. The system comprises a client integrated with a mobile communication device (e.g. PDA, cellular telephone, etc.) and a server communicating via wireless carriers and networks. The server obtains a user's initial position, a user-designated destination, and calculates multiple routes from the user's initial position to the destination. The client displays turn-by-turn navigation instructions to the user using the multiple routes sent by the server. If the client detects a deviation from the multiple routes, the client sends a request for new multiple routes to the server. Then, the server recalculates new multiple routes from the user's current position to the destination and sends navigation information related to the new multiple routes to the client.

### CROSS REFERENCE TO RELATED APPLICATIONS

This application relates to U.S. Pat. No. 6,807,483, “Method And System For Prediction-Based Distributed Navigation,” issued on Oct. 19, 2004, and U.S. patent application Ser. No. 10/619,974, “Method and System for Distributed Navigation” filed on Jul. 15, 2003; both applications being hereby incorporated in its entirety by reference.

### BACKGROUND INFORMATION

1. Field of Invention

The present invention relates generally to navigation systems and location-based information delivery, and more particularly, to a method and system for a multiple route navigation system wherein a client provides navigation guidance using the multiple routes calculated by a remote server.

2. Description of Related Art

Presently, a rapid growth in technological fields such as the personal digital assistant (PDA) and cellular telephones has fueled consumer interest in products that provide on-call real-time guidance and communication. One such technological advance is a navigation system that allows its users to reach destinations by providing turn-by-turn instructions along a calculated route.

Conventional navigation systems are typically satellite-based Global Positioning System (GPS) devices that have been incorporated into automobile navigation systems. Additional information regarding conventional navigation systems can be found in U.S. Pat. Nos. 5,938,720, 5,928,307, 5,922,042, 5,912,635, 5,910,177, 5,904,728, 5,902,350, all incorporated herein by reference. Such conventional automobile navigation systems, however, are expensive and inconvenient to use. Therefore, there is a need to incorporate navigation capabilities so that a user may access real-time turn-by-turn route instructions via personal handheld devices such as a wireless cellular phone or a personal digital assistant (PDA) device.

A variety of systems are known in the art for providing users with electronic routing maps and navigation aids. A typical approach can be found in U.S. Pat. Application Publication 2004/0030493, by Pechatnikov et al., that discloses a method for displaying a corridor map on a mobile client. Such a conventional navigation system, however, has several obstacles to overcome. One such obstacle is the amount of geographic data needed to provide reasonably detailed navigational information. Small handheld devices comprise limited embedded memory that may not be adequate for storing a large amount of geographic information essential for navigational purposes.

Due to limited client memory capacity, conventional distributed navigation systems assign a nominal route calculation tasks to the server, and allocate rerouting calculations almost exclusively to the server. Typically, the client requests a rerouting calculation whenever the user deviates from the nominal route. In order to retrieve and display navigation information to the user, the client must frequently communicate with the server. Such constant communication may be time consuming and the information may be inaccurate due to communication delays. Thus, there is a need for a client-server navigation system, wherein the client can provide navigation guidance to the user without resorting to the server frequently for a new nominal route.

### SUMMARY OF THE INVENTION

The present invention provides a method and system for providing multiple route navigation guidance. The system comprises a client integrated with a mobile communication device (e.g. PDA, cellular telephone, etc.) and a server communicating via wireless carriers and networks.

In one embodiment, the server receives a destination sent by the client, determines a user's initial position and proceeds to calculate a set of destination routes. The server then sends a set of routing information including navigation information related to the set of destination routes to the client and the client displays turn-by-turn navigation instructions to the user. Moreover, while the user is traveling from the initial position to the destination, the client periodically queries the user's position with positioning techniques such as the Global Positioning System (GPS). If a deviation from the set of destination routes is detected, the client sends a request for a new set of destination routes to the server. Then, the server calculates a new set of destination routes from the user's current position to the destination and sends navigation information related to the new set of destination routes to the client.

The present invention reduces excessive reroute communication between the client and the server in a navigation system by storing the navigation information in the client and providing turn-by-turn navigation instruction via the client. The reduced communication between the client and the server further diminishes possible reroute errors caused by communication delays. Moreover, the amount of navigation information stored in the client is dynamic and may depend on factors such as the client's storage and/or processing capabilities.

### BRIEF DESCRIPTION OF THE DRAWINGS

The accompanying drawings that are incorporated in and form a part of this specification illustrate embodiments of the invention and together with the description, serve to explain the principles of the invention:

FIG. 1A is an architectural diagram illustrating an embodiment of an interactive real-time multiple route navigation system.

FIG. 1B is an architectural diagram illustrating an alternative embodiment of an interactive real-time multiple route navigation system.

FIG. 2 is a schematic diagram of server-calculated multiple routes from a user origin to a destination, wherein a client is capable of rerouting independently of the server according to one embodiment of the present invention.

FIGS. 3A-C are schematic diagrams illustrating various approaches to calculate multiple routes at the origin in which the velocity of the user is zero in accordance with one embodiment of the present invention.

FIGS. 4A-B are schematic diagrams illustrating various approaches to predict user's initial position in which the velocity of the user is non-zero in accordance with another embodiment of the present invention.

FIG. 5 is an illustrative flow chart showing the steps for communication between client and server in a real-time multiple route navigation system according to one embodiment of the present invention.

FIG. 6 is an illustrative flow chart showing the steps for determining the origin and calculating multiple routes according to one embodiment of the present invention.

### DETAILED DESCRIPTION

The following description is presented to enable one of ordinary skill in the art to make and use the invention and is provided in the context of a patent application and its requirements. In the following description, specific nomenclature is set forth to provide a thorough understanding of the present invention. It will be apparent to one skilled in the art that the specific details may not be necessary to practice the present invention. Furthermore, various modifications to the embodiments will be readily apparent to those skilled in the art and the generic principles herein may be applied to other embodiments not necessarily enumerated herein. Thus, the present invention is not intended to be limited to the embodiments shown but is to be accorded the widest scope consistent with the principles and features described herein.

One of the key components of a navigation system is the determination of the location (or position) of a user. It is intended that the term location referred to herein comprises a geographic location or geographic information relating to the position of an object. A location may contain three-dimensional information that completely defines the exact position of an object. In some additional embodiments, a location may contain information that is not sufficient to completely define the position of an object. Broadly defined, as used herein, a location also may include speed, time, direction of movement, etc. of an object.

One skilled in the art would appreciate that the format with which a location is expressed is not critical to some embodiments of the invention. For example, in some embodiments, location information is presented in the format of (x, y), where x and y are two ordinates that define the geographic location, i.e., a position of a user. In an alternative embodiment, location information is presented by longitude and latitude related information. In another embodiment of the present invention, the location information also includes a velocity element comprising a speed component and a heading component.

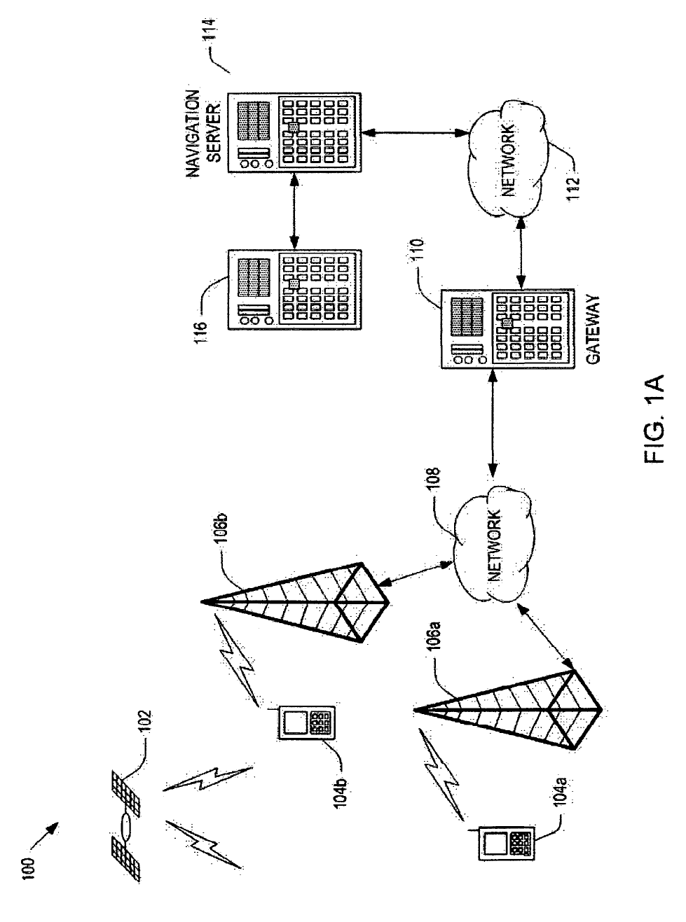

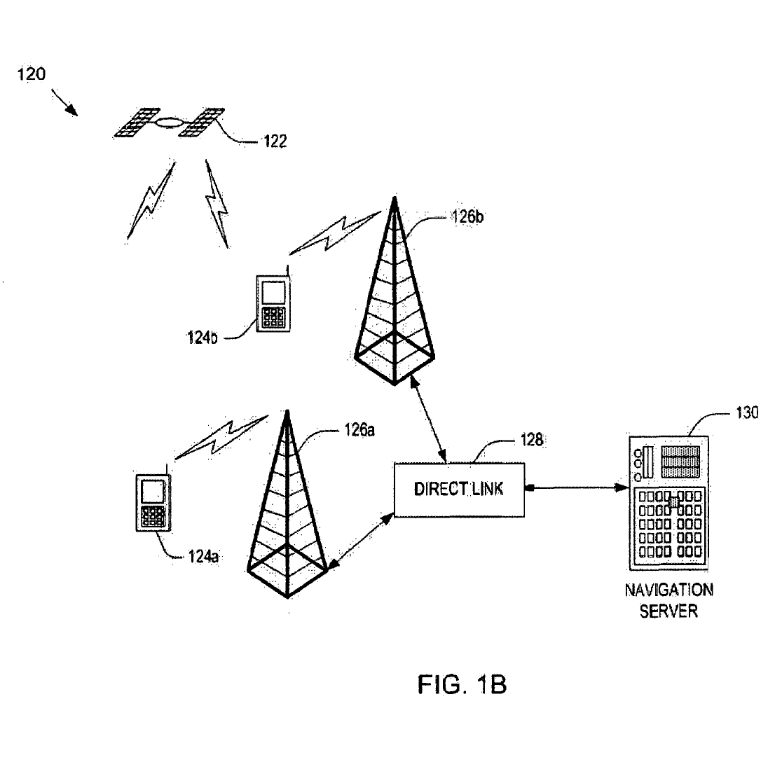

FIG. 1A shows an architecture for an interactive real-time multiple route navigation system 100 in accordance to one embodiment of the present invention. The various components and their interaction will now be described. Wireless device 104 may take the form of a cellular telephone, satellite telephone, wireless Personal Digital Assistant (PDA), personal computer or other suitable device having wireless communications capability. Hereinafter, a term “client device” (or, shortly “client”) may be used interchangeably with the term “wireless device” as one of the major functions of wireless device 104 may be receiving navigation information from a server.

Wireless device 104 may be equipped with positioning capability that takes the form of, for example, Global Positioning Systems (GPS) that may receive signals from a GPS satellite 102, Enhanced 911 (E911), or some other positioning systems as they become available. One skilled in the art will appreciate that the present invention is not limited to any particular positioning technology. In one embodiment, wireless device 104 is manufactured with built-in positioning capabilities. In FIG. 1A, only two wireless devices 104a-b are shown for clarity illustration. However, it should be apparent to those of ordinary skill that the present invention may be practiced with nay number of wireless devices.

Wireless device 104 may not need to carry map information. The only limitation with respect to the memory and CPU is that wireless device 104 has sufficient memory to store multiple routes (or, equivalently, a set of destination routes) transmitted from a server and CPU capability to guide the user using the stored multiple routes, as will be explained later. In one embodiment, the capabilities of wireless device 104 may be enhanced through interfacing with modular attachments. A major function of wireless device 104 is to provide an interface between the invention and a user.

As will be described more fully below, wireless device 104 may provide a user interface for displaying graphical, textual or audible information. The user interface incorporates the user's sensory capabilities within the invention, allowing the user to interact with electromechanical components of the invention, such as by allowing the user to relay and receive location information by means of audible signals, voice, or audiovisual, graphical, or combination thereof of location information displayed or transmitted on wireless device 104. Where a text-displaying device is used, enhanced performance is achieved through wireless device 104 displaying several lines of text. One skilled in the art realizes that many more implementations are possible for wireless device 104 without deviating from the teachings of this invention.

In one embodiment, where wireless device 104 is equipped with directional capabilities such as through the use of gyroscope, geomagnetic sensing, or GPS provided heading, the system 100 may provide real-time directional as well as navigational information. Illustratively, the system 100 may determine that the user must proceed north and the user is facing north, wireless device 104 may display an upward pointing arrow indicating that the user should proceed straight ahead. However, where the user must proceed north and he is facing south, wireless device 104 may show a downward pointing arrow indicating that the user should proceed backward or, more reasonably, turn around to face north and then proceed. In another implementation with a more enhanced display, more detailed and broader map information may be displayed with more stylistic prompts to the user.

In another embodiment, wireless device 104 may be connected to an accessory display. For example, a wireless device 104 appropriate for walking may be enhanced by interfacing with a device with additional features such as a car-mounted display or portable computer to become better equipped for automobile navigation. In certain embodiments of the invention, the accessory device provides, without limitation, enhanced display capabilities, enhanced memory capacity, increased computational power, or increased throughput.

Referring back to FIG. 1A, wireless carrier 106 may provide wireless connectivity between wireless device 104 and navigation server 114 to be described further below. Examples of wireless carrier 106 may include cellular telephone carriers and satellite communications carriers. In achieving wireless connectivity, wireless carriers may provide an existing infrastructure for the wireless devices and distributed navigation servers. Because of the adaptive interaction with the user, information ranging from general to very specific may be relayed to the user for a wide range of navigation applications.

While keeping within the teachings of the invention, wireless carrier 106 may provide positioning information such as through GPS, E911 or other positioning systems. Alternatively, positioning information may be obtained through a third party means and then used by wireless carrier 106. For example, wireless service resellers, wireless internet service providers (ISPs), or satellite wireless carriers, among others, may provide the services necessary to practice the invention. In an embodiment of the invention, wireless carrier 106 may receive and transmit analog or digital information from the wireless device 104 and direct such information downstream to other components of the invention. Similarly, wireless carrier 106 may receive information from components of the invention and then direct such information to wireless device 104.

As shown in FIG. 1A, wireless carrier 106 may be connected to gateway 110 via network 108, wherein gateway 110 may be further connected to navigation server 114 through another network 112. Gateway 110 may be provided by, among others, wireless carriers, ISPs, or other telecommunications providers. In one embodiment of the invention, networks 108 and 112 may be the Internet. The Internet provides advantages because it is a widely distributed network reaching many areas of the world. In another embodiment, networks 108 and 112 may be implemented as a proprietary network. By implementing a specialized network, networks 108 and 112 may be customized to provide minimal latency and optimal performance.

As shown in FIG. 1A, a navigation server 114 may be incorporated as part of the invention by communicating via network 112. Navigation server 114 may comprise street map information, traffic, weather, and other navigation-related as well as points of interest information to facilitate accurate navigation and flexibility. In this manner, wireless device 104 may be not burdened with carrying all the necessary information required to process proper navigation. In one embodiment, navigation server 114 may also process location specific information such as real-time traffic information. In an alternative embodiment, traffic information may be obtained from a separate server 116 of other service providers. By observing and comparing their positions, speeds and times, and making further comparisons with nominal street speed limits in a map database, real-time traffic information may be generated by the server 116 and then directed to the navigation server 114. At each request of multiple route calculation from the wireless device 104, navigation server 114 may dynamically determine new multiple routes for a particular user responsive to ever changing conditions. The technique to determine new multiple routes will be detailed later.

An alternative embodiment 120 of the system architecture of the present invention is shown in FIG. 1B. As shown in FIG. 1B, wireless device 124, GPS satellite 122, wireless carrier 126 and navigation server 130 may be substantially similar to their counterparts described in FIG. 1A. Direct links 128, however, provide an alternative embodiment to the function of gateway 110 and networks 108 and 112 of FIG. 1A. The direct link architecture is applicable where Internet infrastructure is not well established or fast response is desired for user navigation or other location specific information services. Illustratively, TI, Frame Relay, etc. linked by a LAN or WAN are appropriate for direct link 128. In another embodiment, direct links 128 may be implemented as hard-wired connections between wireless carrier 126 and navigation server 130 where wireless carrier 126 and navigation server 130 are collocated in a central office.

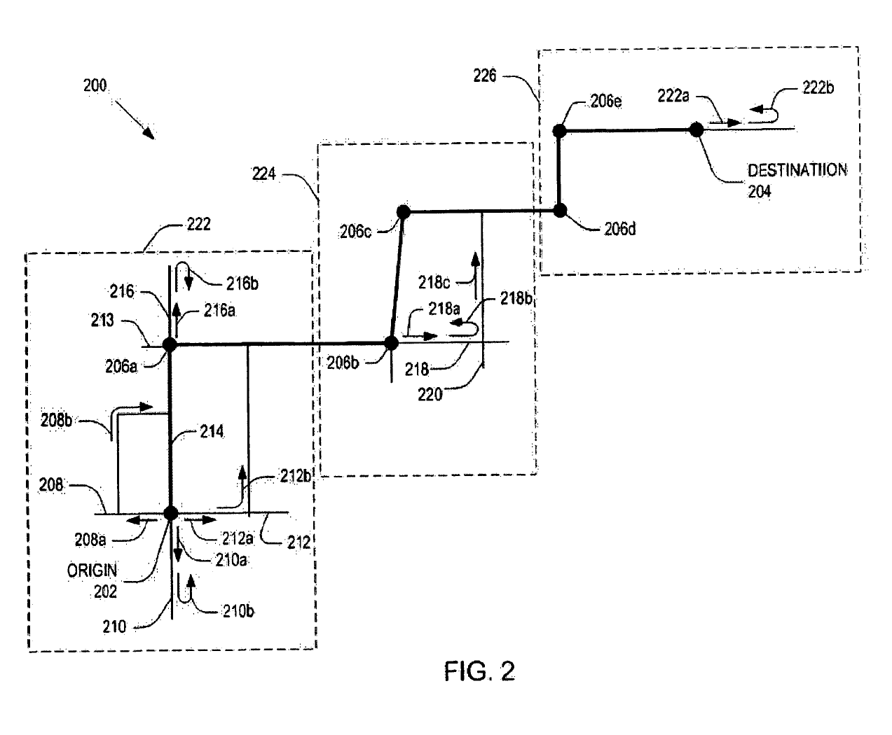

FIG. 2 is a schematic diagram of server-calculated multiple routes 200 from a user origin to a destination, wherein a client is capable of rerouting independently of the server, according to one embodiment of the present invention. As illustrated in FIG. 2, multiple routes 200 may be a vector map and include a user initial position denoted “origin” 202, a destination 204, a preferred route denoted 214, intermediate points 206a-e and road branches 208, 210, 212, 215, 216 and 218. By the term “vector map” is meant that each of the multiple routes comprises a set of coordinates. For the purpose of illustration, only five intermediate points 206 and six road branches 208, 210, 212, 215, 216 and 218 are shown in FIG. 2. However, it should be apparent to those of ordinary skill in the art that the present invention can be practiced with any number of points and branches.

Navigation server 114 receives GPS information from a client 104 to determine the origin 202. The technique to determine the origin 202 will be explained in following sections. Navigation server 114 also receives information of the destination 204 from the client 104. Then, based on origin 202 and destination 204, it may determine multiple routes 200 that may include preferred route 214 and road branches 208, 210, 212, 215, 216 and 218. Each of the road branches 208, 210, 212, 215, 216 and 218 represent a route that the user can take intentionally or unintentionally deviating from preferred route 214.

It is noted that road branch 213 at point 206a may not be included in the multiple routes 200 since it may not be likely that the user may deviate onto the branch 213 by mistake, i.e., the branch 213 is a low risk branch. The risk probability of deviation at each road branch of the intermediate points 206 may be evaluated. In case of low risk probability, such branch may not be included in multiple routes 200 so that the volume of data included in multiple routes 200 may be optimized. The risk probability may be based on several parameters) such as statistical data, geometric complexity of the intersection and size of the branch, etc. The risk probability may be also determined by the user's habit. For example, rather than staying on the calculated multiple routes 200, the user has consistently selected a route that is not included in the multiple routes 200, and the client and/or server may then set the user selected route with zero risk probability.

The amount of navigation information received by client 104 may depend on factors such as user-designated settings or storage and/or processing capabilities of the client 104. In one embodiment of the present invention, the client 104 may receive navigation information for the entire multiple routes 200 from origin 202 to destination 204. In a second embodiment, navigation server 114 may divide multiple routes 200 into several sections, such as sections 222, 224 and 226, of constant (e.g. 100 feet per section) or varying (e.g. 50 feet from the user initial position for the first section, 100 feet for the second section, etc.) distances, and client 104 receives and stores multiple route information for the next section at the end of the current section or the beginning of the next section. In an embodiment where the section lengths are not constant, the length of each section may rely on various factors such as the street and branch density surrounding the section. Moreover, regardless of how multiple routes 200 are divided, client 104 schedules the query of further sections of multiple routes 200 based on factors such as distance consumption and/or user speed. Once the user has traveled into the next section, previous section data may be removed from the storage of client device 104.

Upon receipt of multiple route data from a server, the client 104 may store the multiple routes data and user may start navigation from its origin 202 toward the destination 204 along preferred route 214. The client 104 may provide the user with turn-by-turn instructions along preferred route 214. However, as will be explained later, the user may take one of the branches 208, 210 and 212. Typically, client 104 may update its user location and direction based on the GPS information received from satellite 102. If the client 104 detects a deviation from the preferred route 216 into one of the three branches 208, 210 and 212, it may provide the user with guidance. For example, the client 104 may suggest a u-turn 210b when the user is on the road 210 and proceed in the direction 210a. Likewise, when the user travels on branch (or, equivalently, road) 208 or 212 and proceeds in the direction 208a or 212a, the user may be guided back to the preferred route 214 by an instruction following the direction 208b or 212b, respectively.

As mentioned, client 104 may receive GPS signal continuously and update the user's current position. Deviation from the preferred route 214 is considered “local” if the user's current position is on one of the branches, such as 208, 210 and 212, included in the multiple routes 200. In case of local deviation, the client 104 may guide the user back to the preferred route 214 without requesting calculation of new preferred routes to the navigation server 114, which may translate into savings of excessive reroute communication time between the client 104 and navigation server 114 and computional resources of the navigation server 114. If the user travels on a road that is not covered by the multiple routes 200, the client 104 may request new multiple routes to the navigation server 114, which is a fallback mechanism.

In one embodiment, a predefined or user and/or system set threshold value may be used to determine whether or not the user has deviated from multiple routes 200. The threshold by which deviation is determined may vary depending on the area in which the user is traveling. For example, the threshold may be set relatively low in environments that comprise little noise such as a sparsely populated area or a highway where the positioning measurements are relatively reliable; and the threshold may be set relatively high in environments that comprising a lot of noise such as a business district of a downtown urban area where a multitude of high-rise structures may impair the accuracy of the positioning system. In another embodiment, the deviation detection may be a feature set by user preference and can be turned on or off as desired.

At the intermediate point 206a, the user may be guided back to the preferred route 214 by a u-turn 216b if the user travels in a direction 216a on road 216. As mentioned, if a branch is determined to be at low risk, such as branch 213, the branch may not be included in the multiple routes 200. At the intersection 206b, the user may proceed in a direction 218a. Then, the client 104 may guide the user back to the preferred route 214 by a u-turn on the branch 218b or an alternative approach 218c along a road 220. At the destination 204, the user may overshoot as indicated by an arrow 222a. Then, the client 104 may guide the user to the destination by a u-turn 222b.

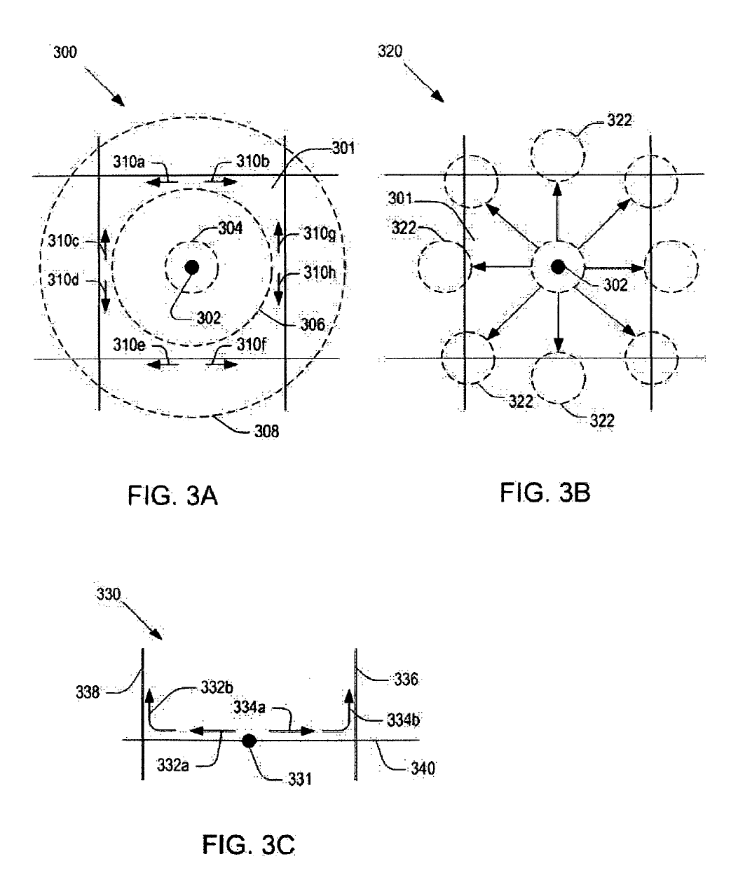

As mentioned above, navigation server 114 may determine origin 202 using GPS information sent by client 104. FIG. 3A is a schematic diagram 300 illustrating one approach to calculate multiple routes at an origin in accordance with one embodiment of the present invention. As shown in FIG. 3A, the origin 302 may be located in a parking lot or a shopping mall 301. In this case, navigation server 114 may not be able to determine which direction the user may select from eight possible directions 310a-h. To calculate multiple routes 200 considering all possible scenarios, navigation server 114 may search nearby roads using concentric circles 304, 306 and 308. Starting from the smallest circle 304, the roads touching the circles 304, 306 and 308 are searched until a satisfactory amount of map data is considered. Then, navigation server 114 may calculate multiple routes 200 that may include all of the possible scenarios. Using the calculated multiple routes 200, the client 104 can guide the user without requesting a new multiple routes.

FIG. 3B is a schematic diagram 320 illustrating another approach to calculate multiple routes at an origin in accordance with one embodiment of the present invention. As in FIG. 3A, the origin 302 may be located in a parking lot or a shopping mall 301. In this case, small circles 322 may be shot around the origin and roads that intersect with the circles are searched until a satisfactory amount of map data is considered. Once the information on nearby roads is collected, navigation server 114 may follow the similar procedures as in the case of FIG. 3A to generate multiple routes 200.

FIG. 3C is a schematic diagram 330 illustrating one approach to calculate multiple routes at an origin in accordance with one embodiment of the present invention. As illustrated in FIG. 3C, the origin 331 may be located on road 340. If the velocity of the user is zero, navigation server 114 cannot determine which direction the user will select from two direction 332a and 334a. In this case, navigation server 114 may calculate multiple routes 200 considering both scenarios. Once the user selects one direction, say 332a, client 104 may guide the user along direction 332b so that the user may proceed on road 338. A similar process may take place if the user chooses direction 334a. In this case, the user may be guided to road 336 via the direction 334b.

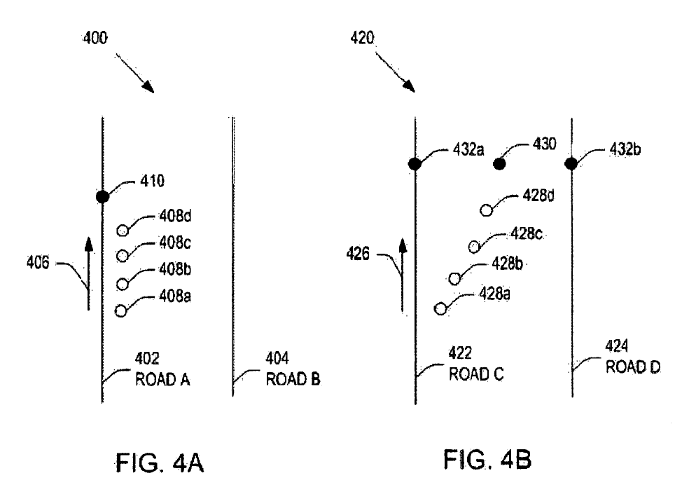

As mentioned, as a fallback mechanism, client 104 may request new multiple routes to navigation server 114 if user travels on a road that is not covered by the initial multiple routes. In this case, user may have certain velocity and, as a consequence, navigation server 114 may receive a series of position information (or, equivalently, location coordinates) from client 104 along with the request. FIG. 4A is a schematic diagram 400 illustrating an approach to predict user's initial position in which the velocity of the user is non-zero in accordance with another embodiment of the present invention. As illustrated in FIG. 4A, user may be traveling in a direction 406 on road A 402 when client 104 requests new multiple routes to navigation server 114 and sends position information 408a-d. Upon receipt of position information 408a-d, navigation server 114 may calculate the user velocity and predict the user location 410 considering the time latency required for the calculation of multiple routes 200. Navigation server 200 may calculate new multiple routes based on the predicted origin 410.

In predicting origin 410, navigation server 114 may need to choose between the road A 402 and road B 404 if position information 408a-d may indicate that user travels between the two roads 402 and 404. The distance between actual road 406 and position information 408a-d may stem from several uncertainty factors. For example, most GPS receivers can provide position information accurate to within a range of approximately 50 meters, i.e., an inaccuracy of around 50 meters. There are a number of other known factors that may affect the accuracy of a position determination. For instance, weather conditions may affect the accuracy of a GPS position determination. In one embodiment of the invention, a position, in addition to information defining the position of an object, is also associated with an estimated error range. One skilled in the art appreciates that the error of a positioning system is estimated based upon the characteristics of the positioning device and other factors including weather and receiving conditions. Therefore, whether or not a position is ambiguous may be dependent upon many factors including, but not limited to: the accuracy associated with the position; attributes of a road network; recent traveling history; and map accuracy. For additional detail related to ambiguity determination, ambiguity reduction, and user location selection, refer to U.S. Pat. No. 6,266,615 entitled “method And System For An Interactive And Real-Time Distributed Navigation System”, issued on Jul. 24, 2001, herein incorporated in its entirety by reference.

In FIG. 4A, the navigation server 114 can readily choose one of them. However, in some cases, navigation server 114 may not be able to choose due to the ambiguity as illustrated in FIG. 4B. FIG. 4B is a schematic diagram 420 illustrating an approach to determine user's initial position in which the velocity of the user is non-zero in accordance with another embodiment of the present invention. As shown in FIG. 4B, user may be traveling in direction 426 on road C 422 when client 104 requests new multiple routes to navigation server 114 and sends position information 428a-d. Upon receipt of position information 428a-d, navigation server 114 may calculate the user velocity and predict the user location 430 considering the time latency required for the calculation of multiple routes 200. In this case, the predicted origin 430 may appear to be in the middle of two candidates 432a and 432b that are located on road C 426 and road D 424, respectively.

To calculate multiple routes 200, navigation server 114 must resolve the ambiguity before a determination can be made of the user's initial position. In one embodiment, it may send a query to client 104. Upon receipt of the query, client 104 may request its user to input the current road. Then, based on the user's input, navigation server 114 may proceed to calculate multiple routes 200.

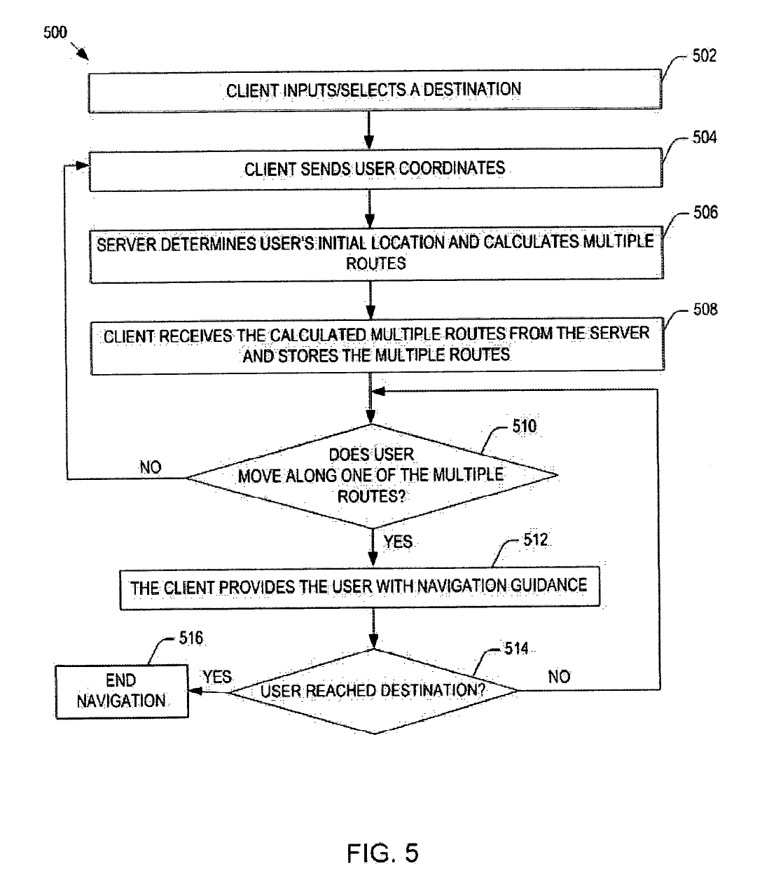

FIG. 5 is an illustrative flow chart 500 showing the steps for communication between client and server in a real-time multiple route navigation system according to one embodiment of the present invention. In step 502, a user may input a destination to a client wherein the client may be integrated with a mobile communication device (e.g. PDA, cellular telephone, etc.). The destination information may be input by voice, by interfacing with the mobile communication device, or by selecting a location from a stored list of addresses. A voice input may be available in multiple languages and the destination may be selected by various methods. In one embodiment, the user may designate to the client a new destination address by means of an interface attached to the mobile communication device. In an alternative embodiment, the user may select from a list of locations such as a list of the user's most recently used destinations, an address list of the user's frequently used destinations (e.g. office address, home address, etc.), a user recorded waypoint, or a preplanned trip list that may be stored in the user's preference settings. Moreover, a destination may be a detailed address such as a home address comprising a building number, a street name, a city name, a state, and a zip code; or a significant landmark such as a major highway.

In step 504, a server obtains from the client a set of initial user position information sent along with a request for navigation instructions. In one embodiment, the client comprises a device such as wireless device 104 discussed with reference to FIG. 1. The server comprises a device such as navigation server 114 also discussed with reference to FIG. 1. In one exemplary embodiment, the client queries a positioning system, such as a GPS system or other positioning systems, to acquire the initial position coordinates associated with the user. In step 506, the server determines the user's initial position according to the initial user position information. Detailed explanation of step 506 will be given later.

In step 506, in addition to determining a user's initial position, the server calculates multiple routes from the user's initial position to the destination selected in step 502. Next, the client receives navigation information related to the multiple routes from the server in step 508. Subsequently, the client continuously queries a positioning system such as GPS to track the user's current position and check if user is traveling on a road defined by multiple routes in step 510. Upon negative answer to the decision diamond 510, the control may proceed to step 504. Otherwise, the client provides the user with turn-by-turn navigation guidance in step 512. In step 514, the client may check if the user has reached the destination. If the answer to step 514 is YES, the navigation ends in step 516. If the answer to step 514 is NO, the control proceeds to step 510. For further detail related to navigation message display, refer to U.S. Pat. No. 6,266,615, entitled “Method And System For An Interactive And Real-Time Distributed Navigation System”, issued on Jul. 24, 2001, herein incorporated in its entirety by reference. In one embodiment, the client may provide warnings for upcoming tight turns, wherein the warnings may be triggered by factors such as user travel speed, angle of the turn, etc. In another embodiment, the client may provide a dynamic local map via a graphic user interface to the user in order to give the user more comprehensive guidance.

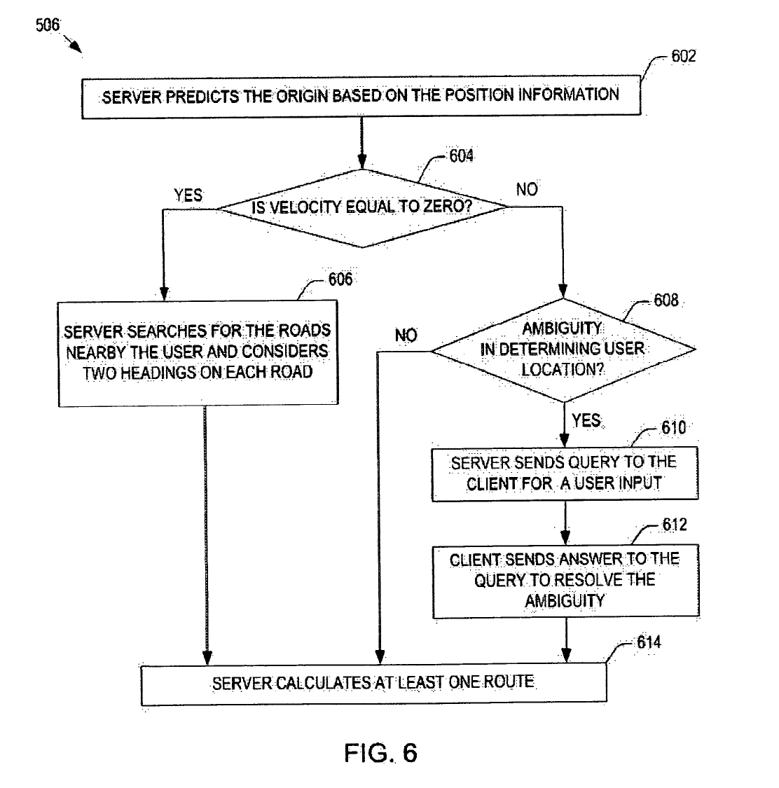

FIG. 6 is an illustrative flow chart showing the details of step 506 for determining the origin and calculating multiple routes according to one embodiment of the present invention. In step 602, the server may determine the origin (or, equivalently, the user's initial position) based on position information received from the client, where the position information may include a series of velocity and location coordinate data. Then, using the position information, the server may determine if the user's velocity is zero in step 604. Upon positive answer to the decision diamond 604, the server may search for possible roads nearby the user and consider two headings for each road in step 606. Then, in step 614, multiple routes may be calculated based on the roads and heading that are found in step 606.

If answer to the step 604 is NO, the server may determine if there is any ambiguity in determining the origin in step 608. Upon negative answer to step 608, the control proceeds to step 614 to calculate the multiple routes. If answer to step 608 is YES, the server may send a query to the client for a user's input in step 610. Upon receipt of the user's input to resolve the ambiguity in step 612, the control proceeds to step 614 to calculate the multiple routes. Additional detail related to determination of user's initial position, refer to U.S. Pat. No. 6,807,483, entitled “Method and System For Prediction-Based Distributed Navigation”, by Chao et al., issued on Oct. 19, 2004, which is herein incorporated in its entirety by reference.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the arts to best utilize the invention and various embodiments with various modifications as are suited to the particular use contemplated. It is intended that the scope of the invention be defined by the Claims appended hereto and their equivalents.

We claim:

1. A navigation system comprising a client and a remote server, wherein a method of providing navigation guidance for a user via the client comprises:
selecting a destination wherein the user selects the destination;
determining a user's initial position;
calculating a set of destination routes via the server, the set of destination routes being a vector map;
sending a set of information from the server to the client, the set of information comprising navigation information related to the set of destination routes;
storing the sent set of information in the client;
providing navigation guidance for the user, wherein the navigation guidance is provided for the user by the client based on the stored set of information; and
monitoring any user deviation from the set of destination routes.

2. The method of claim 1, wherein the user selects the destination from a list of user's most recent destinations, a preplanned trip itinerary or an address booklist.

3. The method of claim 1, wherein the navigation information relates to an entire set of destination routes.

4. The method of claim 1, wherein the navigation information relates to a partial set of destination routes as the user travels along one of the set of destination routes.

5. The method of claim 4, wherein the client discards the navigation information as the user travels outside of the partial set of destination routes.

6. The method of claim 1, wherein the set of destination routes comprises a preferred route.

7. The method of claim 6, wherein the client calculates an alternate route to the destination according to the stored set of information as the user deviates from the preferred route and travels along one of the set of destination routes.

8. The method of claim 1, wherein the vector map comprises a set of coordinates corresponding to the user's initial position, the destination, a set of intermediate points and a set of road branches.

9. The method of claim 8, wherein the set of intermediate points comprises a set of intersections, and wherein a risk probability at each of the set of intersections is higher than a preset threshold.

10. The method of claim 9, wherein the risk probability is based on one or more selected from the group consisting of statistical data, geometric complexity of a corresponding intersection, a size of each road branch at the corresponding intersection and a user's habit.

11. The method of claim 1, wherein the step of determining a user's position is performed using a user's input, a set of user's location coordinates or any combination thereof.

12. The method of claim 1, further comprising:
sending a request for a new set of destination routes from the client to the server as the user deviates from the set of destination routes;
determining a user's new initial position;
calculating a new set of destination routes via the server;
sending the new set of information from the server to the client, the new set of information comprising new navigation information related to the new set of destination routes;
storing the new set of information in the client; and
providing navigation guidance for the user, wherein the navigation guidance is provided for the user by the client based on the stored new set of information.

13. The method of claim 12, wherein the step of determining a user's new initial position comprises the steps of
sending a set of user's location coordinates from the client to the server;
determining a user's initial velocity based on the set of user's location coordinates via the server; and
projecting the user's new initial position based on the determined user's initial velocity and a time latency required for the step of calculating a new set of destination routes.

14. The method of claim 13, wherein the user's initial velocity is zero, and wherein the new set of destination routes comprise at least one road nearby the user's new initial position, the at least one road forming two routes for two possible heading directions.

15. The method of claim 13, wherein the user's initial velocity is non-zero, and wherein said step of determining user's new initial location further comprising:
determining if there is ambiguity in the step of projecting the user's new initial position; and
if there is ambiguity:
sending a query for a user's input from the server to the client; and
sending an answer to the query from the client to the server.

16. A navigation system comprising a client and a remote server, wherein a method of providing navigation guidance for a user via the client comprises:
(a) selecting a destination wherein a user selects the destination;
(b) determining a user's initial position via the server;
(c) calculating a set of destination routes to the destination via the server, the set of destination routes being a vector map comprising a set of coordinates corresponding to the user's initial position, the destination, a set of intermediate points and a set of road branches;
(d) sending a set of information from the server to the client, the information comprising navigation information related to the set of destination routes;
(e) storing the sent set of information in the client
(f) detecting if user deviates from the set of destination routes, wherein if user deviation from the set of destination routes is detected, repeating the steps (b)-(e);
(e) providing navigation guidance for the user, wherein the navigation guidance is provided for the user by the client; and
(g) repeating steps (f)-(g) until the user reaches the destination.

17. A navigation system comprising:
a client for sending a request for a set of routing information to a sever, wherein the request comprises a set of user's location coordinates and a destination; and
a server for receiving the request from the client and in response thereto executing one or more of the following steps: accessing one or more databases, generating a set of destination routes according to the set of user's location coordinates and the destination, and sending to the client a set of routing information related to the set of destination routes,
wherein the set of destination routes is a vector map comprising a set of coordinates corresponding to a user's initial position, the destination, a set of intermediate points and a set of road branches.

18. The navigation system of claim 17, further comprising a wireless carrier coupled to the client for receiving the request from the client and also coupled to the server for relaying the request from the client to the server.

19. The navigation system of claim 18, further comprising one or more direct links coupled to the wireless carrier for receiving the request from the wireless carrier and also coupled to the server for relaying the request from the wireless carrier to the server.

20. The navigation system of claim 18, further comprising a gateway coupled to the wireless carrier for receiving the request from the wireless carrier and also coupled to the server for relaying the request from the wireless carrier to the server.

21. The navigation system of claim 20, further comprising a network coupled to the gateway for receiving the request from the gateway and also coupled to the server for relaying the request from the gateway to the server.
